(19) United States
(12) Patent Application Publication
(10) Pub. No.: US 2023/0184340 A1
(43) Pub. Date: Jun. 15, 2023

(54) AUTOMATIC DRAIN VALVE FOR CONDENSED WATER

(71) Applicant: KD METAL Co.,Ltd., Daegu (KR)

(72) Inventors: Pangon KIM, Daegu (KR); Hyunwoo KIM, Daegu (KR)

(21) Appl. No.: 18/105,220

(22) Filed: Feb. 2, 2023

Related U.S. Application Data
(63) Continuation of application No. PCT/KR2020/011931, filed on Sep. 4, 2020.

(30) Foreign Application Priority Data
Aug. 5, 2020 (KR) 10-2020-0097890

(51) Int. Cl. F16K 5/04; F04B 39/16

(52) U.S. Cl. CPC F16K 5/0414; F16K 5/0471; F04B 39/16

(57) ABSTRACT

The present invention relates to a condensate drain valve, which is connected to a condensate discharge pipe of an air compression equipment, for discharging the condensate generated inside the air compression equipment together with compressed air to the outside, which comprises: a main body; an opening and closing member, and a communication path formed therein for communicating the inlet hole and the discharge hole. According to the present invention, the automatic drain valve for condensed water capable of continuously and automatically discharging the condensed water generated in the air compression device even during the operation of the air compression device can be formed in a compact structure, thereby facilitating the manufacture of the device and remarkably reducing the manufacturing costs.

### CROSS-REFERENCE TO RELATED APPLICATION

This application is a US Bypass Continuation application of International Application No. PCT/KR2020/011931, filed on Sep. 4, 2020, and designating the United States, the International Application claiming a priority date of Aug. 5, 2020, based on prior Korean Application No. 10-2020-0097890, filed on Aug. 5, 2020, the disclosure of which is incorporated herein by reference in its entirety.

### BACKGROUND

### Technical Field

The present invention relates to an automatic drain valve for condensed water and, more specifically, to an automatic drain valve for condensed water having a compact structure capable of continuously and automatically discharging condensed water generated in an air compression device even when the air compression device is operated.

### Background Art

In general, air compression equipment serves to suck air into the atmosphere, compress the air at a predetermined pressure, and then provide the compressed air to various pneumatic devices.

In the air compression equipment, moisture contained in the air is condensed in the process of compressing the air sucked into the air, thereby generating condensed water therein, and when the condensed water is not removed at a proper time, the equipment malfunctions.

In other words, the condensate preferentially flows back to the air compression equipment, such that the function of the air compression equipment is stopped, and the condensate penetrates into various auxiliary facilities controlled by the compressed air, such that the operation of the production line is stopped and the product is defective, thereby causing a serious problem.

Accordingly, the air compression equipment needs to periodically discharge the condensate accumulated in the air compression equipment to the outside by connecting a separate drain valve to the condensate discharge port provided on one side.

Korean Patent No. 1587128 (hereinafter, referred to as “pre-registered patent”), preliminarily filed and registered by the present applicant, discloses a condensate discharge system for an air compression device, including: an air compression device having a condensate discharge pipe formed at one side thereof, the air compression device stopping an operation at a predetermined maximum pressure, resuming the operation at a predetermined minimum pressure, and discharging condensate generated therein; a condensate discharge valve installed at one side of the condensate discharge pipe, and controlling the discharge of the condensate by an opening or closing operation; a pneumatic driving means installed at one side of the condensate discharge valve, and driving the condensate discharge valve in a direction of opening or closing according to an inflow path of compressed air supplied from the air compression device; a path switching means installed at a confluence of a supply line through which the compressed air is supplied from the air compression device to the pneumatic driving means, and switching the inflow path of the compressed air introduced to the pneumatic driving means; and a control means for controlling the path switching means.

The pre-registered patent controls the path switching unit and the pneumatic driving unit through the control unit to open the condensate discharge valve to discharge the condensate when the operation of the air compression device is resumed, and to close the condensate discharge valve after a predetermined time has elapsed to maintain the operational state of the air compression device.

Such a pre-registered patent has an effect of greatly improving productivity by continuously operating the air compression device since condensate water in the air compression device can be continuously discharged even during the operation of the air compression device.

However, the above-mentioned pre-registered patent requires a separate timer to switch the path of the path switching means, and such a timer has a problem in that it is not possible to continuously discharge the condensate water from the inside to the outside during the normal operation of the air compression device due to frequent errors in a high-temperature and high-humidity environment.

In addition, the pre-registered patent requires a plurality of components such as a pneumatic driving unit, a path switching unit, a timer, and the like, and also has a problem that it is cumbersome to manufacture the device and the manufacturing cost of the device is high because the cost of the components is expensive.

### SUMMARY

### Technical Problem

The present invention has been made in an effort to provide an automatic drain valve for condensed water having a compact structure capable of continuously and automatically discharging the condensed water generated in an air compression device even during the operation of the air compression device.

### Technical Solution

To achieve the objective, the present invention provides an automatic drain valve for condensed water which is connected to a condensate discharge pipe of an air compression equipment and discharges the condensate generated inside the air compression equipment to the outside together with compressed air, which comprises: a main body having an accommodation space formed therein, an inlet formed on one side thereof, and a discharge hole formed on the other side thereof; an opening and closing member which is rotatably installed inside the main body, and has an inlet formed on one side corresponding to the inlet, a discharge hole formed on one side corresponding to the discharge hole, and a communication path formed therein for communicating the inlet and the discharge hole; a rotational force providing means for providing rotational force to the opening and closing member by having one end of a rotating shaft coupled to one side of the opening and closing member; and a control means for controlling the operation of the rotational force providing means.

Here, the present invention includes: an inlet pipe which is extended from one side of the main body toward the outer side thereof and has an inlet on one side thereof which is extended; a sealing member which is installed in the inlet pipe, has one end supported on one side of the opening and closing member having the inlet hole, and has a passage therein which connects the inlet hole and the inlet hole; and an elastic member which is interposed between the other end of the sealing member and one side of the inner surface of the inlet pipe, and applies elastic restoring force to the sealing member toward the opening and closing member.

Also, the present invention further includes: a first O-ring disposed on one side of the outer circumferential surface of the opening and closing member to prevent the condensed water introduced into the accommodation space from being introduced toward the outlet; and a second O-ring disposed on the other side of the outer circumferential surface of the opening and closing member to prevent the condensed water introduced into the accommodation space from being introduced toward the rotational force providing means.

Also, the present invention further includes a coupler having one side of which is coupled to either the inlet port or the inlet hole, and the other side of which has at least two inlet ports connected to the inlet port or to the inlet hole.

### BRIEF DESCRIPTION OF THE DRAWINGS

FIG. 1 is a schematic view illustrating a state in which an automatic drain valve for condensed water is installed according to an embodiment of the present invention.

FIG. 2 is a cross-sectional view of an automatic drain valve for condensed water according to an embodiment of the present invention.

FIG. 3 is an exploded cross-sectional view of an automatic drain valve for condensed water according to an exemplary embodiment of the present invention.

FIG. 4A is a view illustrating an open state of the automatic drain valve for condensed water according to the exemplary embodiment of the present invention.

FIG. 4B is a view illustrating a shielding state of the automatic drain valve for condensed water according to the exemplary embodiment of the present invention.

FIG. 5 is a cross-sectional view of an automatic drain valve for condensed water according to another embodiment of the present invention.

### DETAILED DESCRIPTION

According to the present invention, provided is an automatic drain valve for condensed water, which is connected to a condensate discharge pipe of an air compression equipment and discharges condensate generated in the air compression equipment to the outside together with compressed air, which includes: a main body in which an accommodation space is formed and an inlet is formed at one side thereof and a discharge hole is formed at the other side thereof; an opening and closing member which is rotatably disposed in the main body, and has an inlet formed at one side corresponding to the inlet, a discharge hole formed at one side corresponding to the discharge hole, and a communication path formed therein for communicating the inlet and the discharge hole; a rotational force providing means in which one end of a rotating shaft is coupled to one side of the opening and closing member so as to provide rotational force to the opening and closing member; and a control means for controlling the operation of the rotational force providing means.

### Descriptions of Embodiment

Hereinafter, the present invention will be described in more detail with reference to the drawings. It should be noted that the same reference numerals denote the same elements wherever possible in the drawings. Further, detailed descriptions of known functions and configurations that may unnecessarily obscure the subject matter of the present invention will be omitted.

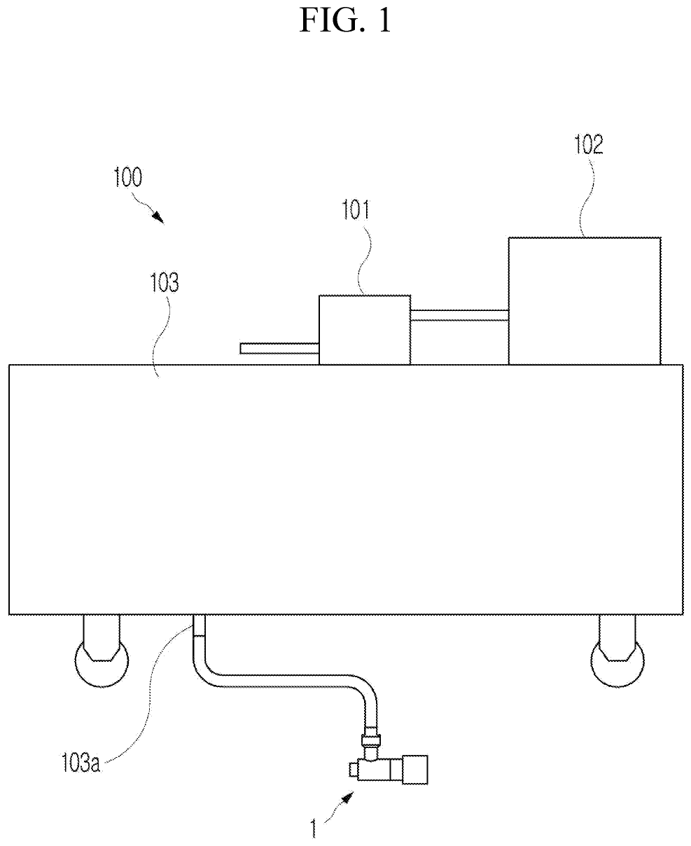

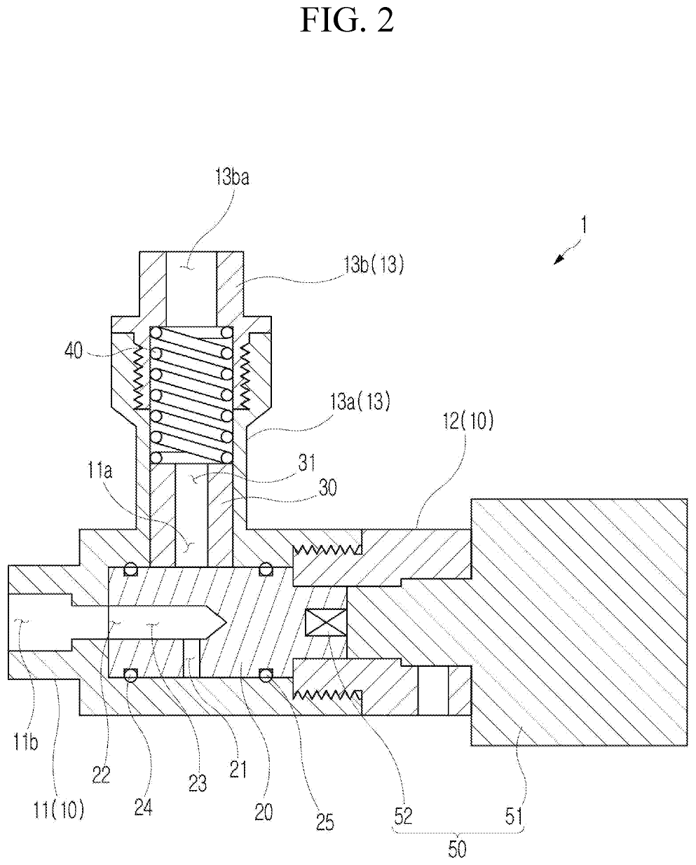

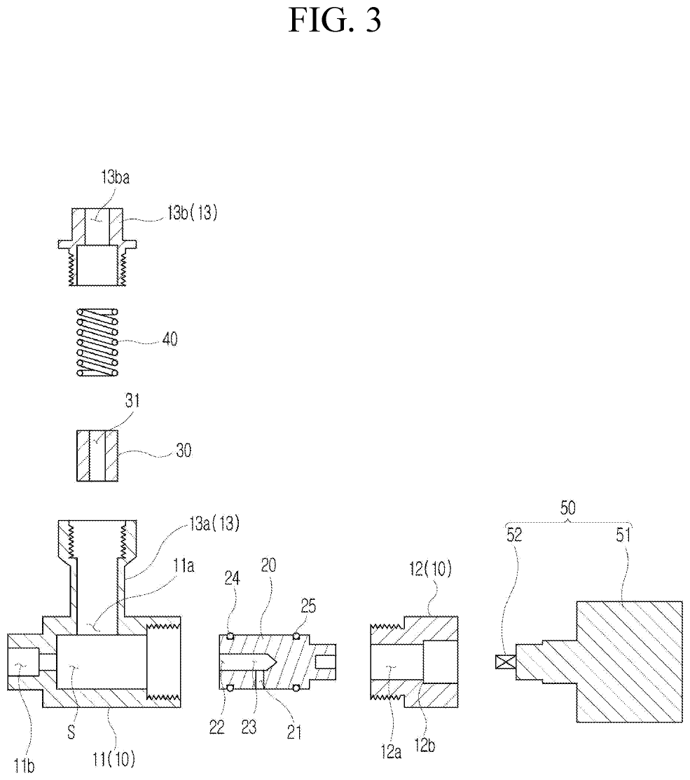

FIG. 1 is a schematic view illustrating a state in which an automatic drain valve for condensed water is installed according to an embodiment of the present invention, FIG. 2 is a cross-sectional view of the automatic drain valve for condensed water according to an embodiment of the present invention, and FIG. 3 is an exploded cross-sectional view of the automatic drain valve for condensed water according to an embodiment of the present invention.

Referring to FIGS. 1 to 3, an automatic drain valve for condensed water 1 according to an exemplary embodiment of the present invention is connected to a condensate water discharge pipe 103a separately provided at a lower portion of an air storage tank 103 of a compression equipment 100 including a driving motor 101, a compression pump 102, and an air storage tank 103 to discharge condensate water generated in the air storage tank 103 to the outside, and includes a main body 10, an opening and closing member 20, a sealing member 30, an elastic member 40, a rotational force providing means 50, and a control means (not shown).

The main body 10 provides an installation region for the opening and closing member 20, the sealing member 30, and the elastic member 40, and includes a body part 11, a socket part 12, and an inlet pipe 13.

The body part 11 has a circular tubular shape, and has an accommodation space S formed therein, an inlet 11a formed at one side of an outer circumferential surface thereof, and an outlet 11b formed at one end thereof.

The socket part 12 is coupled to the other end of the body 11, has an insertion hole 12a formed therein in a length direction to allow the rotational force providing means 50 to be inserted thereinto, and has a support step 12b formed at one side of an inner surface of the socket part, in which the insertion hole 12a is formed, to support one side of the rotational force providing means 50.

The inlet pipe 13 has a circular tubular shape, and includes an extension pipe 13a extending from one side of the body 11 having the inlet 11a in an outward direction, and a cap 13b having one side coupled to the extension pipe 13a and the other side having an inlet hole 13ba communicating with the inlet 11a.

The inlet pipe 13 provides an installation area for the sealing member 30 and the elastic member 40.

The opening and closing member 20 has a cylindrical shape, is rotatably installed in the accommodation space S of the body part 11, has an inlet hole 21 formed at one side of an outer circumferential surface corresponding to the inlet 11a, has a discharge hole 22 formed at one end corresponding to the outlet 11b, and has a communication passage 23 formed therein to communicate the inlet hole 21 and the discharge hole 22.

The opening and closing member 20 allows the inlet 11a and the outlet 11b to be in communication with each other or to be closed according to a rotation position by the rotational force providing means 50, thereby serving to discharge or block the condensate water introduced from the inlet 11a to the outside through the outlet 11b.

In addition, a first O-ring 24 is installed at one side of the outer circumferential surface of one end of the opening and closing member 20, and a second O-ring 25 is installed at one side of the outer circumferential surface of the other end.

Here, the first O-ring 24 serves to prevent the condensed water introduced into the accommodation space S of the main body 10 from being introduced toward the outlet, and the second O-ring 25 serves to prevent the condensed water introduced into the accommodation space S of the main body 10 from being introduced toward the rotational force supply means 50.

The sealing member 30 has a cylindrical shape and is installed in the extension pipe 13a, and has one end supported by one side of the opening and closing member 20 in which the inlet hole is formed, and a moving path 31 communicating the inlet hole 21 and the inlet hole 13ba with each other along a longitudinal direction therein.

The sealing member 30 is supported by one side of the opening and closing member 20 to prevent condensed water introduced from the outside through the inlet pipe 13 from being introduced into the accommodation space S of the body part 11, and may be made of a Teflon material.

The elastic member 40 is interposed between the other end of the sealing member 30 and one side of the inner surface of the cap 13b, and serves to support one end of the sealing member 30 at one side of the opening and closing member 20 by applying an elastic restoring force to the sealing member 30 toward the opening and closing member 20.

The rotational force providing means 50 is for providing rotational force to the opening and closing member 20, and includes a housing 51 and a rotating shaft 52 exposed to the outside of the housing 51.

The rotational force providing means 50 is inserted into the insertion hole 12a of the socket part 12, one side of the housing 51 is supported by the support step 12b of the socket part 12, and the rotating shaft 52 is fixedly coupled to the other end of the opening and closing member 20.

The control means serves to control the rotational speed per minute of the rotational force providing means 50 according to the working environment.

As described above, the apparatus of the present invention is formed into a compact structure unlike the prior art in which a plurality of components, such as the pneumatic driving means, the path switching means, the timer and the like, are required. Thus, the apparatus can be more easily manufactured and manufacturing costs can be significantly reduced.

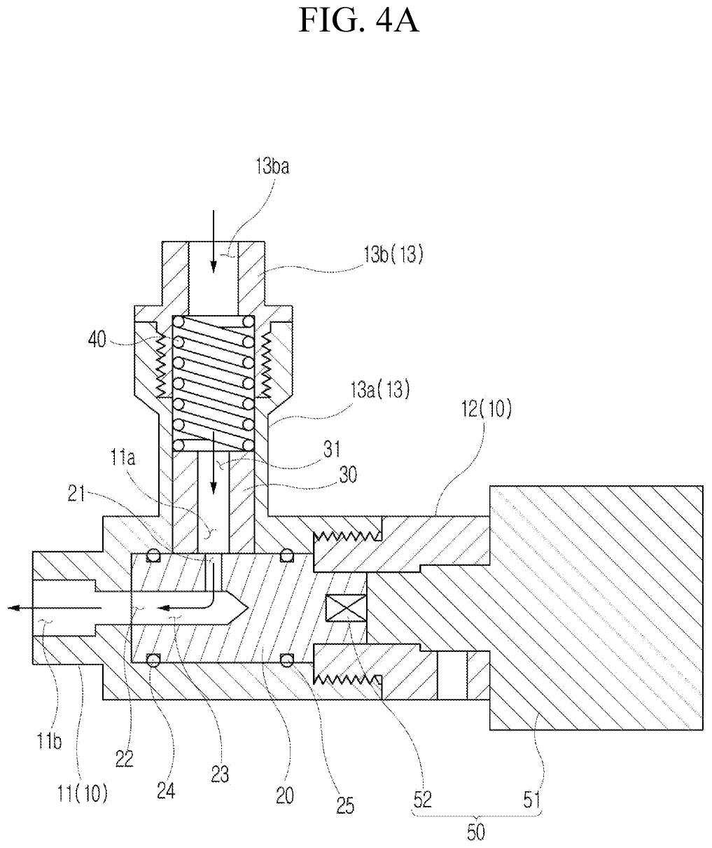

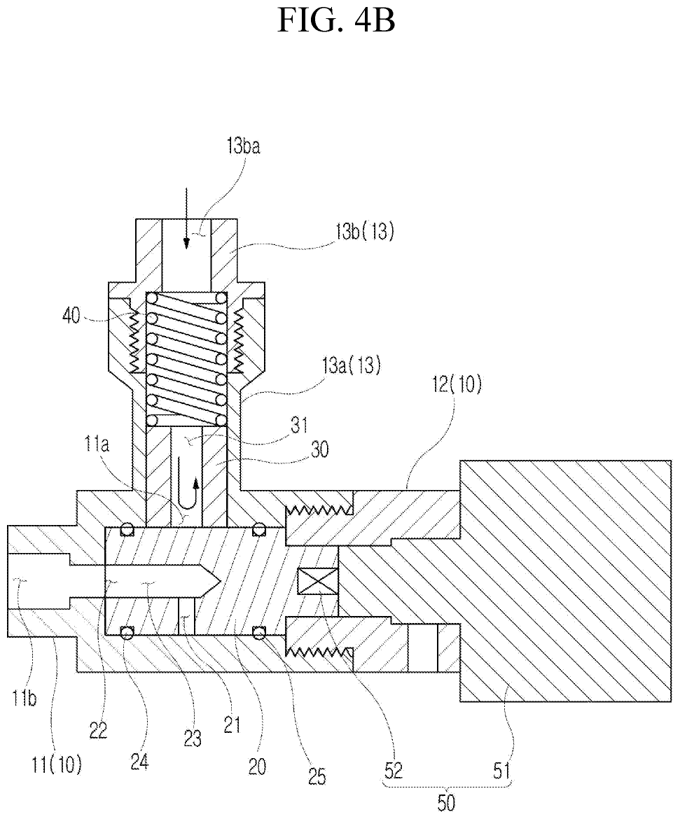

FIG. 4A is a view illustrating an open state of the automatic drain valve for condensed water according to an embodiment of the present disclosure, and FIG. 4B is a view illustrating a closed state of the automatic drain valve for condensed water according to an embodiment of the present disclosure.

As shown in FIG. 4A, in the automatic drain valve for condensed water 1 according to the embodiment of the present invention, when the inlet hole 21 formed on the outer circumferential surface of the opening and closing member 20 communicates with the moving path 31 of the sealing member 30 in a process in which the opening and closing member 20 is rotated by the rotational force of the rotational force providing means 50, the condensed water introduced into the accommodation space S of the main body 10 through the inlet 11a moves through the inlet hole 21, the communication path 23, and the outlet hole 22 of the opening and closing member 20 and is discharged to the outside through the outlet 11b of the main body 10.

In addition, as illustrated in FIG. 4B, when the inlet hole 21 formed in the outer circumferential surface of the opening and closing member 20 does not communicate with the moving path 31 of the sealing member 30, the condensate water introduced into the accommodation space S of the main body 10 through the inlet 11a is prevented from being introduced into the outlet 11b by the first O-ring 24, and thus the discharge of the condensate water is blocked.

As described above, according to the present invention, since condensate water is continuously automatically discharged in a process in which the opening and closing member 20 rotates by the torque providing unit 50, the air compression device can be continuously operated, thereby greatly improving productivity.

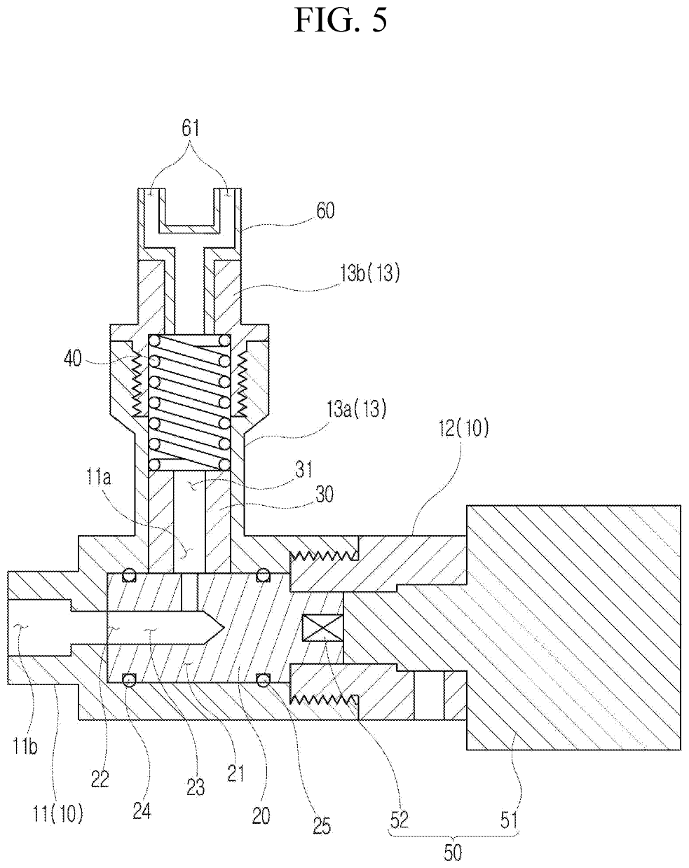

FIG. 5 is a cross-sectional view of an automatic drain valve for condensed water according to another embodiment of the present invention.

Referring to FIG. 5, the automatic drain valve for condensed water 1 according to another embodiment of the present invention is different from the embodiment of the present invention in that it further includes a coupler 60 having one side coupled to the inlet hole 13ba of the inlet pipe 13 and the other side having at least two inlet ports 61 communicating with the inlet hole 13ba, but the remaining components are the same as those of the embodiment of the present invention, and a detailed description thereof will be omitted.

As described above, according to the present invention, at least two inlet ports 61 communicating with the inlet hole 13ba through the coupler 60 are provided, and thus each inlet port 61 and the condensate water outlet of the plurality of air compression equipments may be simply connected to each other through the hose.

Therefore, the present invention does not require a troublesome work of installing multiple automatic drain valves for condensed water 1 on the condensate outlet of each of multiple air compression equipments, and can discharge the condensate of multiple air compression equipments by one automatic drain valve for condensed water 1, thereby significantly reducing costs.

According to the present invention, the automatic drain valve for condensed water capable of continuously and automatically discharging the condensed water generated in the air compression device even during the operation of the air compression device can be formed in a compact structure, thereby facilitating the manufacture of the device and remarkably reducing the manufacturing costs.

Although the present invention has been described with respect to the above preferred embodiments, it is possible to make various modifications or variations without departing from the spirit and scope of the present invention. Accordingly, the appended claims will include such modifications or variations that fall within the subject matter of the present invention.

What is claimed is:

1. An automatic drain valve for condensed water connected to a condensed water discharge pipe of an air compression equipment and discharging condensed water generated in the air compression equipment together with compressed air to the outside, the automatic drain valve comprising:
a main body having an accommodation space formed therein, an inlet formed at one side thereof, and a discharge hole formed at the other side thereof;
an opening and closing member rotatably installed in the main body, and having an inlet hole formed at one side corresponding to the inlet hole, a discharge hole formed at one side corresponding to the discharge hole, and a communication path formed therein, the communication path communicating the inlet hole with the discharge hole;
a rotational force providing means having one end of a rotating shaft coupled to one side of the opening and closing member to provide rotational force to the opening and closing member; and
a control means controlling an operation of the rotational force providing means.

2. The automatic drain valve for condensed water of claim 1, further comprising:
an inlet pipe extending from one side of the main body toward the outside and having an inlet formed at one side thereof;
a sealing member installed in the inlet pipe, having one end supported at one side of the opening and closing member having the inlet hole formed therein, and having a moving path formed therein to communicate the inlet hole with the inlet hole; and
an elastic member interposed between the other end of the sealing member and one side of the inner surface of the inlet pipe, and applying an elastic restoring force to the sealing member toward the opening and closing member.

3. The automatic drain valve for condensed water of claim 1, further comprising:
a first O-ring installed at one side of an outer circumferential surface of the opening and closing member and preventing the condensate water introduced into the accommodation space from being introduced toward the outlet; and
a second O-ring installed at the other side of the outer circumferential surface of the opening and closing member and preventing the condensate water introduced into the accommodation space from being introduced toward the rotational force supply means.

4. The automatic drain valve for condensed water of claim 1, further comprising a coupler having one side coupled to any one of the inlet or the inlet hole and having at least two inlets connected to the inlet or the inlet hole formed on the other side.
